(19) United States
(12) Patent Application Publication
(10) Pub. No.: US 2013/0282404 A1
(43) Pub. Date: Oct. 24, 2013

(54) INTEGRATED ACCESS TO AND INTERATION WITH MULTIPLICITY OF CLINICA DATA ANALYTIC MODULES

(71) Applicants: Angel Janevski, New York, NY (US); Sitharthan Kamalakaran, Pelham, NY (US); Christian Reichelt, Bruchsal (DE); Nilanjana Banerjee, Armonk, NY (US); Vinay Varadan, New York, NY (US); Nevenka Dimitrova, Pelham Manor, NY (US)

(72) Inventors: Angel Janevski, New York, NY (US); Sitharthan Kamalakaran, Pelham, NY (US); Christian Reichelt, Bruchsal (DE); Nilanjana Banerjee, Armonk, NY (US); Vinay Varadan, New York, NY (US); Nevenka Dimitrova, Pelham Manor, NY (US)

(21) Appl. No.: 13/976,170

(22) PCT Filed: Jan. 4, 2012
(86) PCT No.: PCT/IB12/50041

§ 371 Date: Jun. 26, 2013

Related U.S. Application Data
(60) Provisional application No. 61/430,564, filed on Jan. 7, 2011.

(51) Int. Cl. G06F 19/00

(52) U.S. Cl. CPC G06F 19/3443
USPC 705/3

(57) ABSTRACT

A state machine (22) stores a current state (30) comprising a clinical context defined by available patient-related information relating to a medical patient, and identifies one or more available analytical tools of a set of analytical tools (24) that are applicable to the current state. A graphical user interface module (16) receives a user selection of an available analytical tool. The state machine loads patient-related information (40) to the user-selected available analytical tool (24ₛₑₗ) and invokes the user-selected available analytical tool to operate on the loaded patient-related information to generate additional patient-related information relating to the medical patient and/or graphical patient-related content relating to the medical patient. The state machine transitions from the current state (30) to a next state (30′) and/or invokes the graphical user interface module to display the graphical patient related content.

This application claims the benefit of U.S. Provisional Application No. 61/430,564 filed Jan. 7, 2011. U.S. Provisional Application No. 61/430,564 filed Jan. 7, 2011 is incorporated herein by reference in its entirety.

The following relates to the medical arts, clinical decision support arts, automated medical data analytics arts, and related arts.

Clinical decision support (CDS) systems have been developed to provide automated access to the accumulated medical knowledge developed by ongoing medical research, clinical trials, case studies, and diverse other informational sources. The CDS system provides electronic search capability over a large medical database that suitably augments the professional experience and knowledge of human clinicians, and ensures that the most current medical knowledge is available to the clinician in making medical decisions.

One type of CDS system employs a clinical guideline that has been developed and maintained by medical experts. A typical clinical guideline is specific to a particular medical condition or class or other grouping of medical conditions. In one configuration, the guideline is a nodal graph in which nodes represent patient states and edges between nodes delineate clinical decisions and/or changes in the patient state. For example, in an oncological clinical guideline, the nodes may be defined in terms of cancer type and stage, patient age, gender, or other characteristics, other concurrent conditions (e.g., heart condition), results of various medical tests (e.g., genetic assays, imaging-based tumor assessment, or so forth), and so on. A transition (or “graph edge”) in this example represents a change in the cancer stage, receipt of results of a certain medical test, onset (or remission) of a concurrent condition, or so forth. In using the clinical guideline, the patient's state is located at the graph node that best represents the patient's condition, and the graph edges leading away from that node indicate possible progressions of the patient case. For example, with the patient situated at a certain node, the edges may include a recommendation to perform an imaging study. If the physician agrees with this CDS recommendation then the physician orders the test and, based on the test result the patient state transitions to a new node of the clinical guideline.

A problem with the clinical guideline approach for CDS systems is that it is premised upon the patient substantially comporting with the guideline. That is, the patient must “fit into” some node of the patient guideline, and the various clinical options represented by edges leading away from that node must represent credible possible case progressions. However, anecdotal evidence suggests that around 20% of cancer patients do not fit into any suitable guideline. This percentage can be even higher depending on how the fitness is defined and the actionable steps available to the clinician and the patient. In such cases, the CDS system will typically provide little flexibility to explore all available options that are loosely or not at all built in the clinical guidelines.

Another approach is a rules-based CDS system. Here, the “graphical” guideline is replaced by a set of clinical decision rules. Each rule includes a set of preconditions, and if the patient satisfies the preconditions then the rule is deemed applicable and provides guidance for the physician. The rules-based approach is reliant upon the patient satisfying the preconditions of at least one rule so as to provide relevant guidance. Like the guideline approach, the diversity of patients ensures that a substantial fraction of cases will not comport well with the available rules, and in these cases the rules-based CDS system will provide limited guidance.

In sum, the applicability of existing guideline- or rules-based CDS systems to “real” patients is less than comprehensive, leaving physicians with little or no guidance from the CDS system for certain patient cases.

Existing CDS systems also typically have little or no integration with automated analytical tools or modules. Typically, the CDS guideline or rule will recommend performing a particular test using a particular analytical tool. If the physician agrees with this recommendation, then the physician (or other medical personnel) apply the analytical tool to perform the test. This entails collecting the requisite patient data and inputting it to the analytical tool. The tool then generates a test result that is then input to the CDS, either manually or via some record-keeping automation (e.g., the test result is stored in the electronic patient record that is also accessed by the CDS system). This new test result may then be used by the CDS system to generate further recommendations.

The following contemplates improved apparatuses and methods that overcome the aforementioned limitations and others.

According to one aspect, an analytical tool integration system is disclosed for guiding a user in utilizing a set of analytical tools. The analytical tool integration system comprises a state machine configured to store a current state comprising a clinical context defined by available patient-related information relating to a medical patient and to identify one or more available analytical tools of the set of analytical tools that are applicable to the current state, and a graphical user interface module in operative communication with the state machine and configured to receive a user selection of an available analytical tool. The state machine is further configured to load patient-related information to the user-selected available analytical tool and to invoke the user-selected available analytical tool to operate on the loaded patient-related information to generate at least one of additional patient-related information relating to the medical patient and graphical patient related content relating to the medical patient. The state machine is further configured to perform at least one of: transitioning from the current state to a next state comprising clinical context defined by available patient related information including the additional patient related information; and invoking the graphical user interface module to display the graphical patient related content. The state machine and the graphical user interface module suitably comprise an electronic data processing device including a graphical display device and at least one user input device.

According to another aspect, an analytical tool integration method is disclosed for guiding a user in utilizing a set of analytical tools. A current clinical context defined by available patient-related information relating to a medical patient is stored. One or more available analytical tools of the set of analytical tools are identified to a user that are applicable for the current clinical context, and a user selection of an available analytical tool is received from the user. The user selected available analytical tool is invoked to operate on patient-related information to generate an output including at least one of additional patient-related information relating to the medical patient and graphical patient related content relating to the medical patient. The output is responded to by at least one of: updating the current clinical context to include the additional patient related information made available by the invoking, and displaying the graphical patient related content. The storing, identifying, invoking, and responding are suitably performed by an electronic data processing device.

According to another aspect, a non-transitory storage medium is disclosed that stores instructions executable by an electronic data processing device to perform a method as set forth in the immediately preceding paragraph.

One advantage resides in presenting patient-related data in a timely fashion to assist clinicians during analysis of a patient case.

Another advantage resides in providing an analytical tool integration system and method for guiding a user in utilizing a set of analytical tools.

Another advantage resides in more efficient integrated use of analytical tools.

Another advantage resides in reduced manual data entry in using analytical tools.

Numerous additional advantages and benefits will become apparent to those of ordinary skill in the art upon reading the following detailed description.

The invention may take form in various components and arrangements of components, and in various process operations and arrangements of process operations. The drawings are only for the purpose of illustrating preferred embodiments and are not to be construed as limiting the invention.

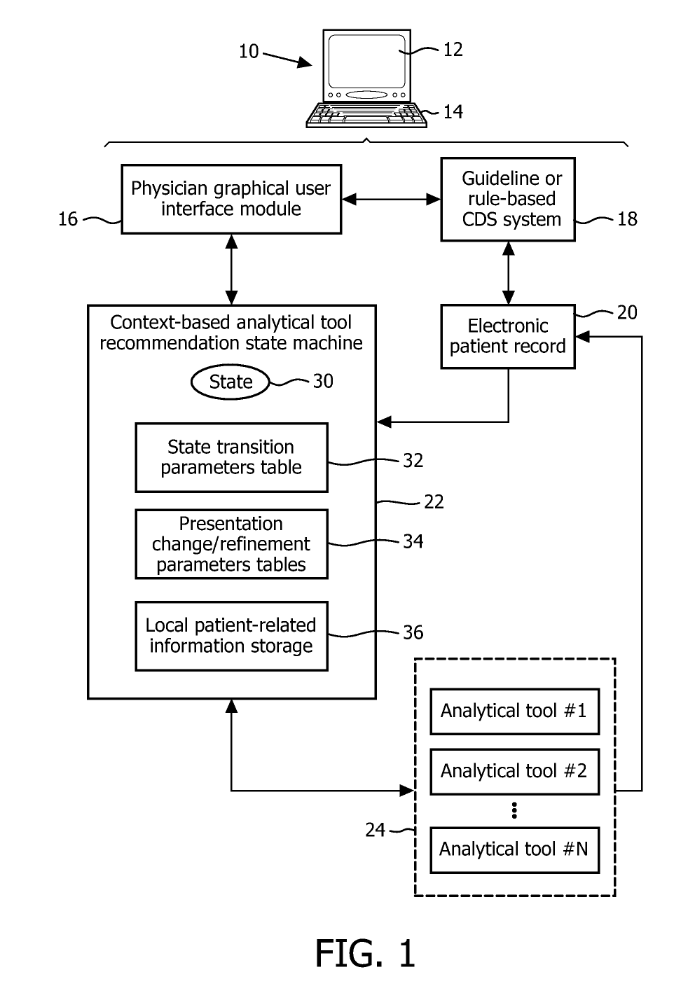

FIG. 1 diagrammatically shows a clinical decision support (CDS) system, a set of analytical tools, and an analytical tool integration system for guiding a user in utilizing the set of analytical tools.

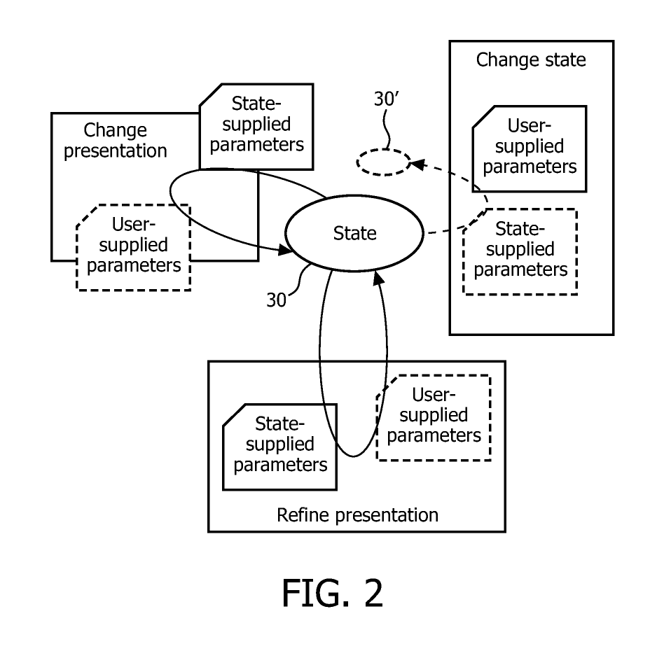

FIG. 2 diagrammatically shows operation of the context-based analytical tool recommendation state machine of FIG. 1.

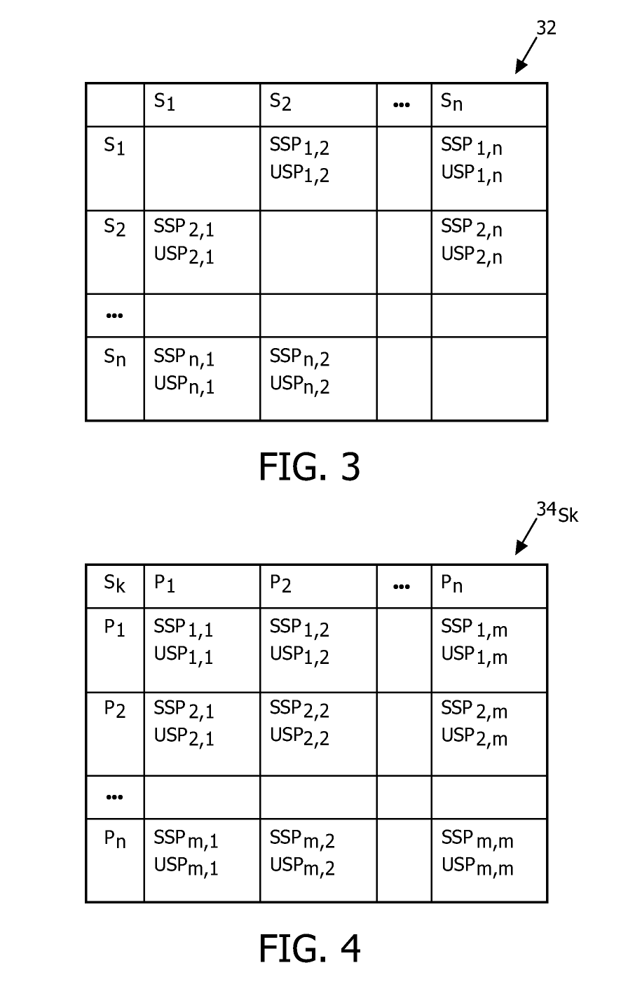

FIG. 3 diagrammatically shows the state transition parameters table of FIG. 1.

FIG. 4 diagrammatically shows the presentation change/refinement parameters table of FIG. 1 for a state Sₖ.

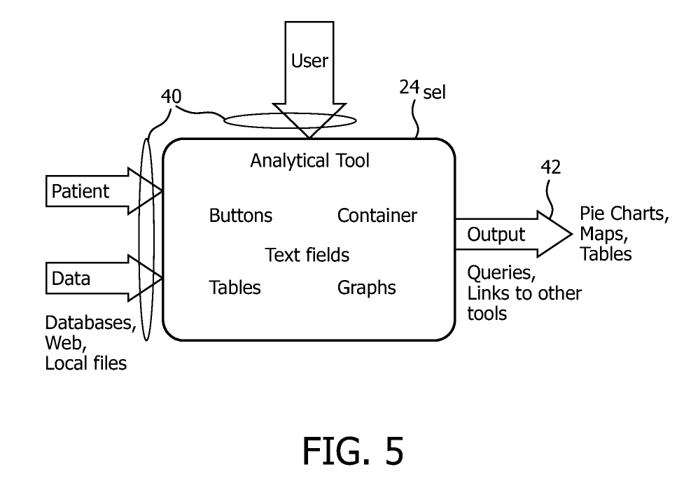

FIG. 5 diagrammatically shows operation of one of the analytical tools of FIG. 1 under control of the analytical tool control module of FIG. 1.

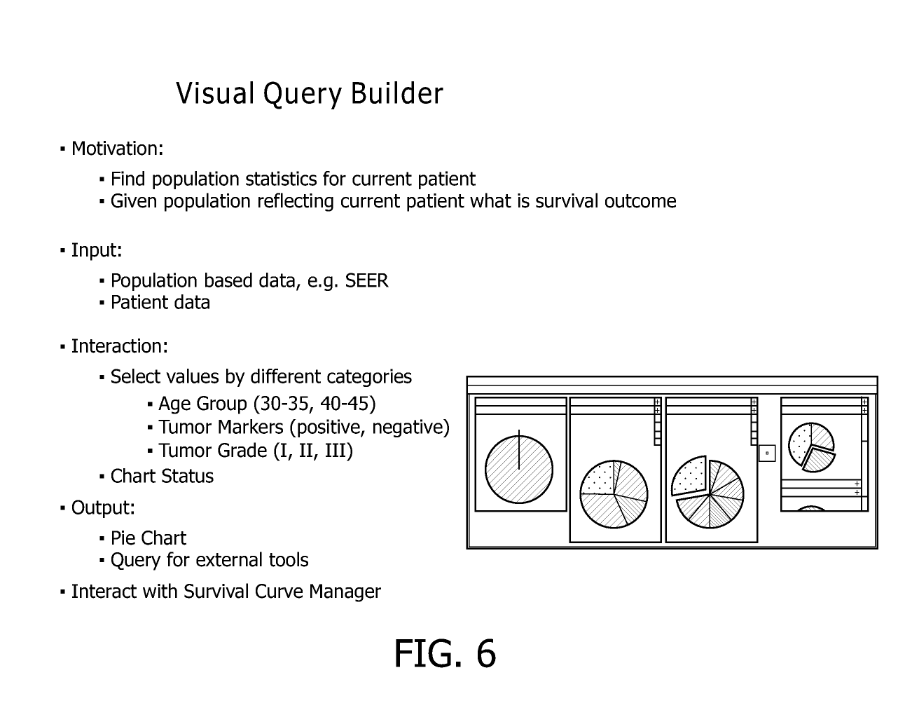

FIGS. 6-12 diagrammatically show operation of various analytical tools under control of the analytical tool control module of FIG. 1.

With reference to FIG. 1, a medical system implemented by a computer or other electronic data processing device 10 having a display device 12 (such as an LCD display, projection display, or so forth) and at least one user input device (such as an illustrative keyboard 14, or a mouse, trackball, trackpad, or other pointing device, or so forth) includes a graphical user interface (GUI) 16 (utilizing the input/output hardware 12, 14), a guideline- or rules-based clinical decision support (CDS) system 18, an electronic patient record 20 or other patient data repository, and a context-based analytical tool recommendation state machine 22. The CDS system 18 may employ a clinical guideline, e.g. a nodal graph, that is displayed via the GUI 16 along with various annotations corresponding to the current node representing the patient and various edges extending away from the current node and representing various possible progressions of the patient treatment. Additionally or alternatively, the CDS system 18 may employ a rules-based paradigm in which a set of rules developed by appropriate medical experts are applied by the CDS system to generate clinical recommendations.

The electronic patient record 20 is an electronic database storing patient data. The electronic patient record 20 may have varying degrees of comprehensiveness. In some embodiments all patient medical data is stored in the electronic patient record 20, including: medical images; physician notes; physiological monitoring records (e.g., electrocardiograph, SpO₂, blood pressure, and so forth); molecular data (e.g., genetic sequencing data for the patient, microarray data, results of discrete molecular marker tests, and so forth); hematology test results; oral intake records (for in-patients); and so forth. Alternatively, the electronic patient record 20 may be less comprehensive, e.g. storing some but not all of the above illustrative information. In some embodiments the electronic patient record 20 may be located elsewhere than the computer 10 on which the GUI 16, optional CDS system 18, and context-based analytical tool recommendation state machine 22 reside. For example, the computer 10 may be a physician's personal computer whereas the electronic patient record 20 may be maintained at a hospital database. In the same way, the context-based analytical tool recommendation state machine 22 and the optional CDS system 18 may reside on different computers. Moreover, the computer 10 may be embodied by a plurality of computers collectively defining a computing “cloud” or other aggregative and/or network-based electronic data processing device.

It is also to be appreciated that the disclosed analytical tool integration systems and methods for guiding a user in utilizing a set of analytical tools may be embodied as a non-transitory storage medium storing instructions executable by an electronic data processing device (e.g., the computer 10) to perform the method. The non-transitory storage medium may, for example, comprise a hard disk drive or other magnetic storage medium, or an optical disk or other optical storage medium, or a random access memory (RAM), read-only memory (ROM), flash memory or other electronic storage medium, or so forth.

A clinician (e.g., physician, medical specialist, or so forth) treating a patient utilizes patient data stored in the electronic patient record 20, and optionally also consults the CDS system 18 for clinical recommendations. In some instances, however, the patient case may not comport with the clinical guideline or rules employed by the CDS system 18, in which case the CDS system 18 provides limited probative information. In some instances the patient case may comport with the clinical guideline or rules and the CDS system 18 thus provides substantial probative information; nonetheless, the clinician may want to explore other sources of information or perform other analyses on the patient data and/or other patient-related information. In some embodiments, the CDS system 18 may be omitted entirely—that is, the CDS system 18 is to be considered an optional component.

In any of these cases, the clinician suitably utilizes one or more analytical tools of a set of analytical tools 24 in order to explore the patient case. Without loss of generality FIG. 1 assumes that the set of analytical tools 24 includes N tools where N is a positive integer. By way of illustrative example, some contemplated analytical tools include: a visual query builder tool that generates population charts of patients of a population respective to a category (e.g., a chart of patients having, e.g. stage 2, cancer respective to different age categories); a survival curves manager tool that plots a Kaplan-Meier Survival Plot showing statistical survival rates of specific population groups; a biological pathway visualizer tool providing a graphical representation of a biological pathway suitably labeled with annotations based on molecular test data of the patient; a geographical trial finder tool that locates clinical trials performed respective to a medical condition relevant to the patient; a medical literature search tool that facilitates keyword-based searching of a medical literature database; an interactive word cloud tool that provides information about related medical terms for use in facilitating various keyword-based search operations; and so forth. These are merely illustrative examples, and other analytical tools may be provided. In general, an analytical tool operates on patient-related information relating to a medical patient to generate at least one of (1) additional patient-related information relating to the medical patient and (2) graphical patient-related content relating to the medical patient.

In general, the various analytical tools may be located in various places. Some analytical tools may be “local”, e.g. embodied as software executing on the same computer 10 on which resides the GUI 16, optional CDS system 18, and context-based analytical tool recommendation state machine 22. Some analytical tools may reside on a hospital server computer and are accessed via a hospital data network. Similarly, some analytical tools may reside on a remote server computer substantially anywhere in the world and are accessed via the Internet.

Conventionally, the clinician would use such an analytical tool by manually collecting and loading relevant patient-related information to the analytical tool and invoking the analytical tool to operate on the loaded patient-related information to generate additional patient-related information and/or graphical patient-related content. In the embodiment of FIG. 1, however, these time-consuming and human error-prone operations are at least partially replaced by operations performed by the context-based analytical tool recommendation state machine 22. Additionally, the context-based analytical tool recommendation state machine 22 provides guidance for the clinician by suggesting analytical tools based on a clinical context that is defined by the available patient-related information relating to the medical patient.

With continuing reference to FIG. 1, the context-based analytical tool recommendation state machine 22 is a state machine which stores a current state 30 of the medical patient. The current state 30 comprises a clinical context defined by available patient-related information relating to the medical patient. When invocation of an analytical tool generates additional patient-related information this typically changes the clinical context and, as a consequence, causes the state machine 22 to transition from the current state 30 to a next state. On the other hand, if the invocation of the analytical tool does not generate additional patient-related information, then the state 30 does not change; however, graphical patient-related content output by the analytical tool is suitably displayed by the GUI 16 and this may entail a change or refinement of the data presentation to the user. A state transition parameters table 32 identifies the state-supplied and user-supplied patient-related information (i.e., parameters) that are input to the analytical tool to generate additional patient-related information leading to a change of state. Similarly, presentation change/refinement parameter tables 34 (one table per state) identify the state-supplied and user-supplied patient-related information (i.e., parameters) that are input to the analytical tool to generate a change or refinement of the presentation. Typically, the state-supplied parameters are filled in by data stored in the electronic patient record 20 while the user-supplied parameters are filled in by user input via the GUI 16. The context-based analytical tool recommendation state machine 22 also includes or has access to a local patient-related information storage 36 that stores user-supplied parameter values and buffers or stores any state-supplied parameter values not readily retrievable from the electronic patient record 20.

The context-based analytical tool recommendation state machine 22 suitably performs a method to access clinical information from a variety of data sources (i.e., analytical tools) and data types in the context of a current patient. In addition, the state machine 22 enables results from one data access (i.e., analytical tool invocation) to be streamlined into a task that queries another data source. In addition, this approach can be customized to the preferences of a clinician and/or the clinical institution.

For example, in a standard clinical setting in a leading cancer center, clinicians may typically be interested in linking the current patient with molecular profiling data (e.g. pathway activation status) and link to therapies that may benefit the patient. Based on a molecular profile of the patient (e.g. gene expression sequencing or microarray) a link is made to an available biological pathway visualization tool that translate this information in conjunction with other patient data to provide information to the clinician regarding details of the pathways that are deregulated and as such may be candidates for specific therapies. Furthermore, based on the parts (genes) that are deregulated in suspect pathways can be used to form queries against a literature search tool and/or a clinical trials finder tool to locate relevant literature and/or clinical trials that are relevant to this patient.

In another example, in a community hospital setting the focus of the clinician may be to link the patient to the epidemiological and therapy data, as well as to provide a convenient link to ongoing studies in nearby clinical centers for which the patient is eligible. Toward this end, a visual query builder tool may be invoked to analyze the epidemiological/therapy data of a population, and a geographical trial finder tool may be invoked to locate nearly clinical studies into which the patient may be enrolled.

In some illustrative examples set forth herein, the context-based analytical tool recommendation state machine 22 manages interactions with analytical tools in order to process data of the types shown in Table 1.

TABLE 1
data types

| Data Type | Clinical Need | Use Example |
|---|---|---|
| Epidemiological | Population based Studies, | SEER Database is used to |
| Data | Population Statistics, | drive “Adjuvant! Online”, |
| | Decision making tools | widely used tool in |
| | | Breast Cancer Oncology |
| Molecular Data | Molecular Profiling | GGI - a 97-gene measure of |
| | | histological tumor grade |
| Clinical Trials | Trials as basic | Therapy Decisions, |
| Information | mechanism of discovery | Enroll patients in trials |
| | in clinic | |
| Clinical | Dissemination of | Cancer Biology, |
| Literature | Knowledge | Drug Information, |
| | | Study Reports, etc. . . . |

Table 1 is merely illustrative, and it will be appreciated that the context-based analytical tool recommendation state machine 22 can readily be configured to manage interactions with analytical tools providing processing of other data types.

With reference to FIG. 2, an illustrative example of operation of the state machine 22 of FIG. 1 is diagrammatically shown. The state machine 22 provides a visual interaction paradigm that connects the information available and applicable to the present state 30 of the patient (that is, to the current context of the patient) thus allowing the user (clinician) to easily perform various follow-up steps including: refining the existing presentation of the data by invoking a suitable analytical tool that generates refined graphical patient-related content; changing the visual presentation of the data by invoking a suitable analytical tool that generates changed graphical patient-related content; or invoking an analytical tool that would effectively introduce a new state of interaction (that is, that would generate additional patient-related information causing the state machine 22 to transition from the current state 30 to a next state 30′ (see FIG. 2)—thereafter, the “next state” 30′ is the current state for future operations. While FIG. 2 shows these as separate operations, it is also contemplated that the invocation of a single analytical tool may both change/refine the presentation and change the state, e.g. by generating both graphical patient-related content and additional patient-related information.

In all transitions (e.g., change or refinement of the presentation and/or change of state), there are two types of inputs that assist in relieving the user from having to unnecessarily supply information that is already available to the user. State-supplied parameters (SSP) are defined for each state and each task. These are automatically “filled in” by the state machine 22 and are passed on to the invoked analytical tool. A set of additional user-supplied parameters (USP; 0 or more) are specified for a transition and these the user supplies or confirms pre-filled values at the time of the action requested, typically via interaction with the GUI 16. In some embodiments the state machine 22 and the graphical user interface module 16 are configured to display at least a portion of the state-supplied parameters generated from the clinical context for optional editing by the clinician via the graphical user interface module 16 prior to loading the state-supplied parameters with said optional editing to the user-selected available analytical tool.

With reference to FIGS. 3 and 4, the parameters are defined for each state with respect to available presentations or applicable state transitions. FIG. 3 diagrammatically shows the state transition parameters table 32 of the state machine 22. The table 32 identifies the parameters for the various possible state-to-state transitions. In FIG. 3, the notation SSP_{i,j} stands for state-supplied parameters for transition from state to state j. Similarly, the notation USP_{i,j} stands for user-supplied parameters for transition from state i to state j. For any given current state (e.g., current state Sₖ in the example of FIG. 4), a similar table 34_{Sk} of the tables 34 of FIG. 1 defines the parameters for a presentation change and/or refinement when in the state Sₖ. In FIG. 4, the notation SSP_{i,j} stands for state-supplied parameters for change from presentation i to presentation j (for state Sₖ) and similarly, the notation USP_{i,j} stands for user-supplied parameters for change from presentation i to presentation j (again, for state Sₖ). These are the “off-diagonal” elements of the table 34_{Sk}. The “on-diagonal” elements of the table 34_{Sk} pertain to presentation refinement. Here, the notation SSP_{i,i} and USP_{i,i} stand for the state-supplied parameters and the user-supplied parameters, respectively, for refinement of presentation i.

With reference back to FIG. 1 and with further reference to FIG. 5, the invocation of an analytical tool by the context-based analytical tool recommendation state machine 22 is described. The state machine 22 identifies one or more analytical tools of the set of analytical tools 24 that are applicable to the current state 30. An analytical tool is applicable to the current state 30, and hence is an available analytical tool if: (1) the clinical context defined by the available patient-related information relating to the medical patient is sufficient for the analytical tool to operate (that is, there is no “missing” data that would prevent the analytical tool from operating) and (2) the analytical tool can be reasonably expected to be probative of the patient in the current state 30 by providing additional patient-related information, graphical patient-related content, or both. Since the number of analytical tools in the set of analytical tools 24 is finite (e.g., typically N corresponds to a few tools to perhaps a few dozen tools) identification of the available analytical tools for a given state can be done in an exhaustive fashion, e.g. as a table (not shown) of available tools for each possible state. The GUI 16 in operative communication with the state machine 22 is configured to recommend the available analytical tools and to receive a user selection of an available analytical tool. The recommendation by the GUI 16 can take various forms, such as a suitably annotated hyperlink to an available analytical tool shown in the current presentation to the user. In FIG. 5 an illustrative user-selected available analytical tool 24ₛₑₗ is diagrammatically indicated. The state machine 22 is further configured to load patient-related information 40 (see FIG. 5) to the user selected available analytical tool 24ₛₑₗ and to invoke the user selected available analytical tool 24ₛₑₗ to operate on the loaded patient related information 40 to generate an output 42 including at least one of additional patient-related information relating to the medical patient and graphical patient related content relating to the medical patient.

With reference to FIGS. 6-12, some illustrative examples of invocation of various analytical tools is described.

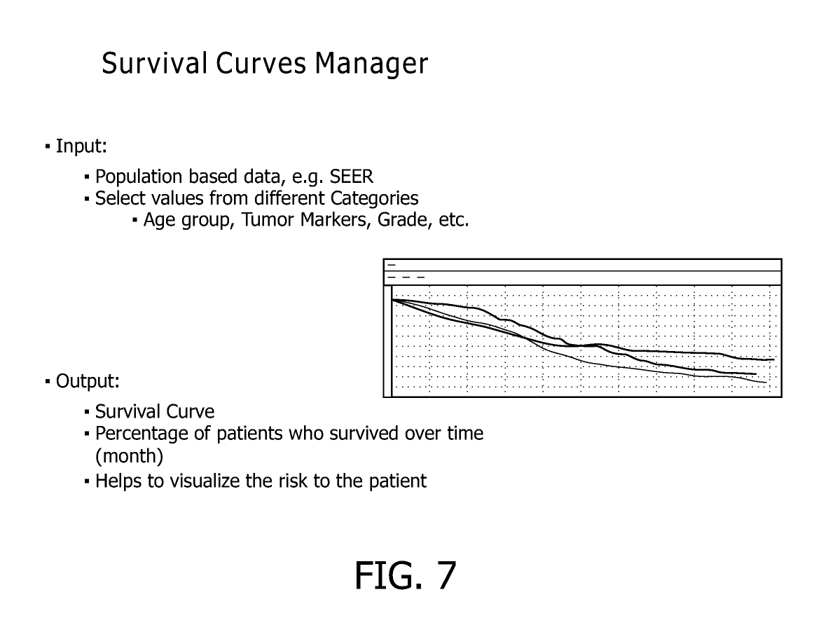

With reference to FIGS. 6 and 7, tools for analyzing epidemiological/historical data are described. FIG. 6 diagrammatically shows operation of a visual query builder tool which graphically presents, in the form of pie charts or another type of population chart, epidemiological information for the current patient respective to a category such as age groups, cancer stage, marker types, location of tumor, or so forth. These can also be nested pie charts (pie of pie, bar of pie) and 3D pie charts (as well as exploded pie charts). Instead of a pie chart, another type of population chart that is preferred by the clinical expert can be used (bar charts, radar, bubble, doughnut etc). Such flexibility is useful because there is a multitude of clinical parameters available to be examined, and a single representation and a simple clicking interaction may be too cumbersome. The visual query builder tool can potentially save time and discover hidden relationships in the data. In a suitable embodiment, the population data analyzed by the visual query builder tool is a MySQL database, such as a hospital records database, Surveillance Epidemiology and End Results (SEER) statistical database, or so forth, and may be part of the electronic patient record 20 (which stores records for all patients at the hospital or other medical facility—suitable anonymization should be applied before data presentation) and/or in anonymized data collection repositories. The GUI 16 can then be used as an input mechanism. Examples of analyses that can be performed using the visual query builder tool include: comparing treatments; comparing survival outcomes of patients belonging to different groups or different treatments; identifying side effects and co-morbidities based on the overlaid data; performing hierarchically decomposition of the data with the nested pie charts or another hierarchically driven representation where the clinical expert decides on the levels of the nesting; and employing an automatic visualization mode that automatically calculates and shows the appropriate level of nesting: for example, starting with the TNM tumor classification, the next levels may include hormone receptor status, followed by the treatment response to a chemotherapy regimen, dose, (and still further by pharmaceutical brand, and so forth).

The presentation of the output of the visual query builder tool may optionally include a link to a survival curves manager tool (see FIG. 7). The link is a recommendation to invoke the (now available) survival curves manager tool. Selection of the link generates a query to the survival curves manager tool which generates a Kaplan-Meier-Survival Plot or other survival curve for a particular population group identified by the user through operation of the visual query builder tool. The survival curves manager tool becomes an available analytical tool because the visual query builder tool generates additional patient-related information in the form of a dataset for the particular population group identified by the clinician using the visual query builder tool. This causes the state machine 22 to change to a next state for which the survival curves manager tool is an available analytical tool.

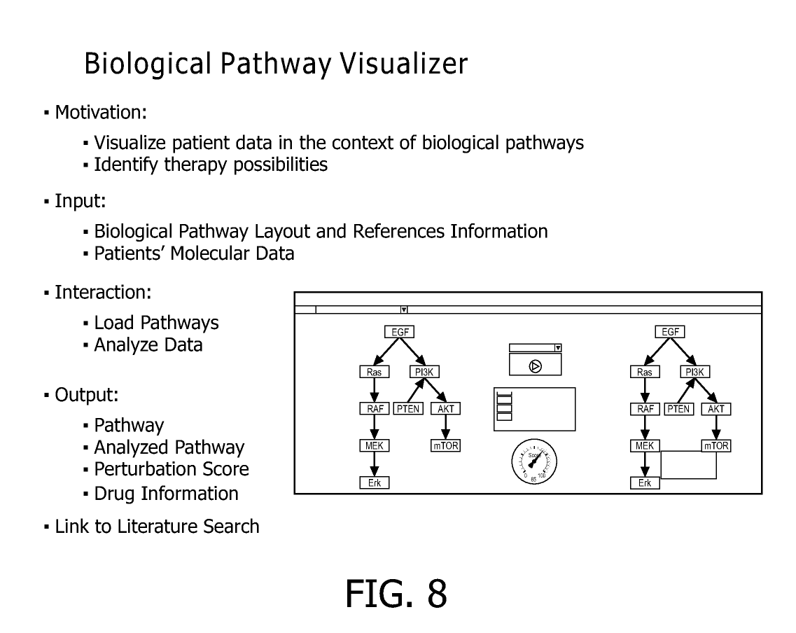

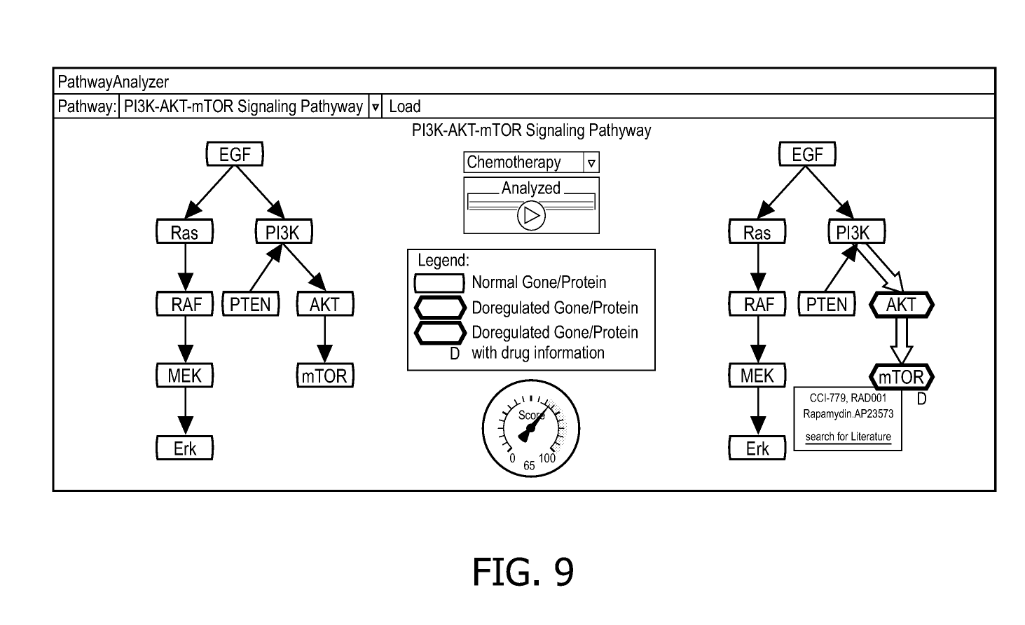

With reference to FIGS. 8 and 9, a biological pathway visualizer tool is described. This analytical tool provides visualization of pathway data and overlays (or annotates) patient molecular data onto the displayed pathways, and also displays relevant information such as activation/de-regulation of critical genes and drug information targeting those genes. The biological pathway visualizer tool takes as loaded input data (1) a biological interaction/network map in a pre-defined format such as a BioPax format, and (2) molecular data for the medical patient derived from a patient sample (e.g., Affymetrix data, sequencing data, pathology data, or other measurements). The biological pathway visualizer tool performs a network analysis on this loaded data and provides as output an overlay or other annotation of measurements onto a graphical display of the genes and their interactions (i.e., graphical patient-related content including a graphical representation of the pathway with annotated information generated from the patient molecular data), the activation/deactivation state of these genes and relevant clinical information such as drugs that target these genes, side-effects that could be identified by measurement of state of the genes, or so forth. FIG. 9 shows an illustrative example of graphical patient-related content suitably generated by the biological pathway visualizer tool. In this illustrative example, a dashboard is presented with different symbols indicating the severity (in other embodiments, the symbols may be replaced by different colors, e.g. red, yellow, and green indicating progressively less severity). The display provides a readily apprehended representation of pathway interactions and potential chemotherapy benefits. In the graphical representation, pathway interactions may be visualized by color or stacked bar or pie chart or so forth to show the individual disturbance on each gene (feature) within that pathway for (1) the medical patient, (2) an average of a patient population (possibly derived by the visual query builder tool of FIG. 6), or (3) both the medical patient and the population, e.g. by overlaying concentric circles for each patient and colors for intensity of the present feature. These pathway interactions can be visualized in a pre-treatment vs. post-treatment manner when the data is available on the same graphical representation in order to give visual impression of the chemotherapy impact on each individual gene. In one approach, a gene or other feature is represented by a circle that is divided into two halves where left half is activity of the gene/feature before treatment and the right half is activity of the gene/feature after the treatment. The clinical expert can readily visualize these alterations with respect to chemotherapy benefit for a single pathway, then zoom out to do this for a group of biologically related pathways (e.g. signaling and cell-adhesion) and then zoom out to a disease group of pathways (e.g. cancer pathways, metabolic pathways, et cetera).

In the specific illustrative example shown in FIG. 9, the mTOR feature is annotated as a deregulated gene/protein as indicated by the molecular data for the medical patient. Additionally, the annotation indicates drug information is available, specifically pertaining to the CCI-779 chemotherapy drug which is classified as an mTOR inhibiter. The annotation also includes a hyperlink labeled “search for Literature”. Selection of this hyperlink brings up a literature search tool. More generally, the subject of annotation could be any deregulated gene/protein or pathway segment for which drug information is available.

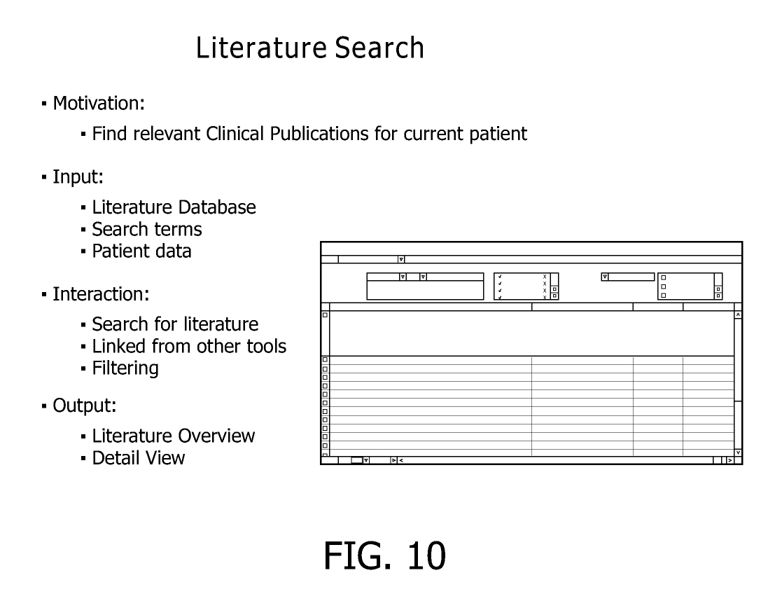

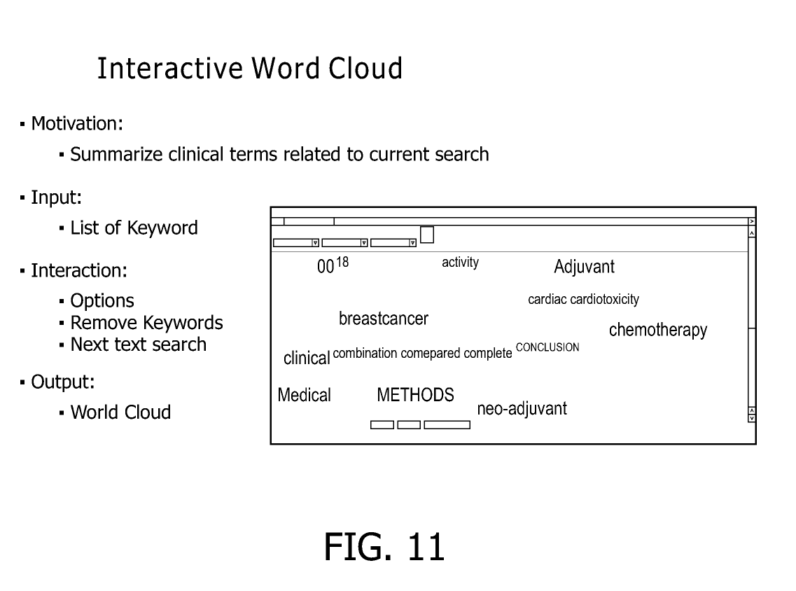

With reference to FIGS. 10 and 11, an embodiment of a literature search tool is described. The literature search tool (FIG. 10) allows the clinician to query medical literature databases such as Pubmed, and visualizes the query results in a graphical format such as a word clouds (see FIG. 11). Starting from the example of FIG. 9, selection of the hyperlink labeled “search for Literature” generates a query including suitable terms such as “CCI-779”, “mTOR”, et cetera, which is input to the literature search tool. This enables the clinician to quickly obtain the relevant medical literature without manually formulating the query. In general, the literature database could be an online or offline text based repository such as Pubmed, Pathology, Radiology reports, or so forth. In this example the word cloud (FIG. 11) is an output of the literature search (FIG. 10). Alternatively, the word cloud (FIG. 11) can be used to generate additional search terms for use in the literature search tool (FIG. 10) or for use in another user-selected available analytical tool that receives a search term as an input.

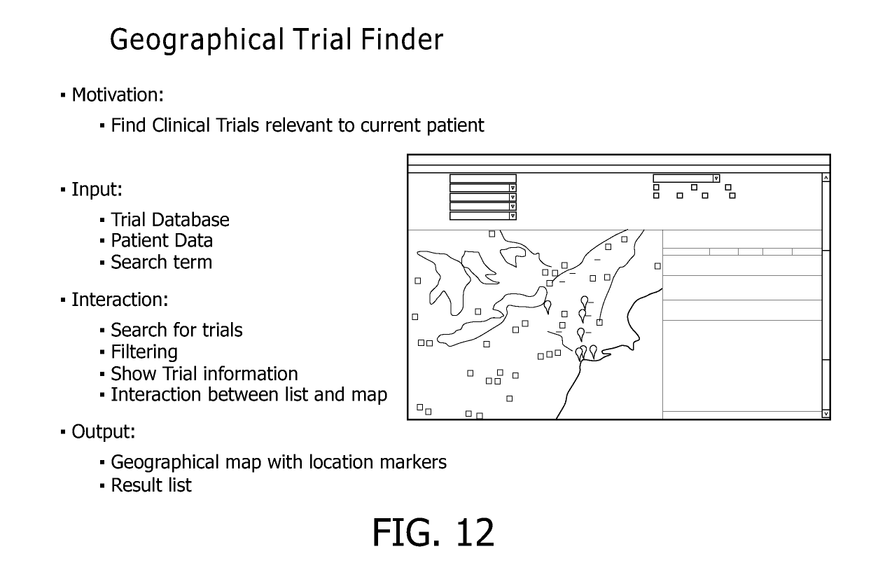

With reference to FIG. 12, a geographical trial finder tool is described. In a suitable embodiment, this tool overlays clinical trial information onto an electronic map (e.g. a Google map). The clinical trial information may be obtained, for example, by querying the website www.clinicaltrials.gov, extracting results including geographical information (e.g., zip code), and translating the zip code into longitude-lattitude data and overlaying it onto a Google map (or any other maps tool).

The embodiments described herein with reference to FIGS. 6-12 are merely illustrative examples. More generally, the context-based analytical tool recommendation state machine 22 can usefully integrate analytical tools of various types. Some other analytical tools that may be usefully integrated by the state machine 22 are described, for example, in Christian Reichelt, “Access, Handling and Visualization Tools for Multiple Data Types for Breast Cancer Decision Support” (Diploma's Thesis, University of Heidelberg Faculty of Medical Informatics, 2011).

In various illustrative embodiments described herein, a graphical query engine is provided that can query integrated hospital or population records and present information on clinically relevant actions—such as defining treatment plan for patient, identifying side effects based on previously identified cases/records present in the relevant databases. In some embodiments, a pathway analyzer and interaction interface is provided by which meaningful biological pathways can be queried by the clinician to obtain pathway/network analysis in a graphical map. The level of disregulation and impact is shown visually together with clinically actionable intelligence associated with the pathway. A workflow is provided that allows seamless interaction with hospital records, epidemiological records and other proprietary or publically available databases to automatically retrieve relevant clinical information based on current patient status (Age group, disease type, location, prognosis etc.). In some embodiments case based records/statistics retrieval is provided for patient data. Some embodiments include graphical input and output designs.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. An analytical tool integration system for guiding a user in utilizing a set of analytical tools, the analytical tool integration system comprising:
a state machine configured to store a current state comprising a clinical context defined by available patient-related information relating to a medical patient and to identify one or more available analytical tools of the set of analytical tools that are applicable to the current state; and
a graphical user interface module in operative communication with the state machine and configured to receive a user selection of an available analytical tool;
wherein the state machine is further configured to load patient-related information to the user-selected available analytical tool and to invoke the user-selected available analytical tool to operate on the loaded patient-related information to generate at least one of additional patient-related information relating to the medical patient and graphical patient-related content relating to the medical patient and to perform at least one of:
transitioning from the current state to a next state comprising clinical context defined by available patient-related information including the additional patient-related information, and
invoking the graphical user interface module to display the graphical patient-related content; and
wherein the state machine and the graphical user interface module comprise an electronic data processing device including a graphical display device and at least one user input device.

2. The analytical tool integration system of claim 1, wherein the state machine is configured to load patient-related information including at least state-supplied parameters generated from the clinical context.

3. The analytical tool integration system of claim 2, wherein the state machine is configured to load patient-related information further including user-supplied parameters that are not generated from the clinical context and that are input via the graphical user interface module.

4. The analytical tool integration system of claim 2, wherein the state machine and the graphical user interface module are configured to display at least a portion of the state-supplied parameters generated from the clinical context for optional editing by a user via the graphical user interface module prior to loading the state-supplied parameters with said optional editing to the user-selected available analytical tool.

5. The analytical tool integration system of claim 1, wherein the set of analytical tools includes a visual query builder tool and wherein, responsive to user selection of the visual query builder tool:
the state machine loads patient-related information to the visual query builder tool comprising state-supplied parameters generated from the clinical context including at least population-based data and at least one user-supplied parameter including a user-selected patient category and invokes the visual query builder tool to operate on the loaded patient-related information to generate graphical patient-related content including a population chart of the population represented by the population-based data respective to the user-selected patient category.

6. The analytical tool integration system of claim 5, wherein the population chart comprises a pie chart having slices corresponding to population groups of the user-selected patient category.

7. The analytical tool integration system of claim 1, wherein the set of analytical tools includes a survival curves manager tool and wherein, responsive to user selection of the survival curves manager tool:
the state machine loads patient-related information to the survival curves manager tool comprising at least population-based data for a user-selected population group and invokes the survival curves manager tool to operate on the loaded patient-related information to generate graphical patient-related content including a survival curve of the user-selected population group computed from the population-based data.

8. The analytical tool integration system of claim 7, wherein the user-selected population group is selected by user interaction with a visual query builder tool of the set of analytical tools.

9. (canceled)

10. (canceled)

11. (canceled)

12. (canceled)

13. (canceled)

14. (canceled)

15. The analytical tool integration system of claim 1, wherein the graphical user interface module is configured to receive the user selection of an available analytical tool as a user selection of a portion of graphical patient-related content displayed by the graphical user interface module responsive to a previous user selection of an available analytical tool.

16. The analytical tool integration system of claim 15, wherein:
the graphical patient-related content displayed by the graphical user interface module responsive to a previous user selection of an available analytical tool comprises one or more survival curves; and
the user selection comprises selection of a geographical trial finder tool by user selection of a displayed survival curve, the state machine being loading patient-related information including at least patient population information associated with the user-selected survival curve to the user-selected geographical trial finder tool.

17. The analytical tool integration system of claim 15, wherein:
the graphical patient-related content displayed by the graphical user interface module responsive to a previous user selection of an available analytical tool comprises a graphical biological pathway representation annotated based on molecular data of the medical patient; and
the user selection comprises selection of a medical literature search tool by user selection of a displayed deregulated gene/protein or pathway segment annotated with drug information, the state machine being loading patient-related information including at least the annotated drug information to the user-selected medical literature search tool.

18. An analytical tool integration method for guiding a user in utilizing a set of analytical tools, the analytical tool integration method comprising:
storing a current clinical context defined by available patient-related information relating to a medical patient;
identifying to a user one or more available analytical tools of the set of analytical tools that are applicable for the current clinical context and receiving from the user a user selection of an available analytical tool;
invoking the user-selected available analytical tool to operate on patient-related information to generate an output including at least one of additional patient-related information relating to the medical patient and graphical patient-related content relating to the medical patient; and
responding to the output by at least one of:
updating the current clinical context to include the additional patient-related information made available by the invoking, and
displaying the graphical patient-related content;
wherein the storing, identifying, invoking, and responding are performed by an electronic data processing device.

19. The analytical tool integration method of claim 18, wherein the invoking includes loading one or more parameters generated from the clinical context into the user-selected available analytical tool.

20. The analytical tool integration method of claim 19, wherein the invoking further includes loading at least one user-supplied parameter that is not generated from the clinical context into the user-selected available analytical tool.

21. The analytical tool integration method of claim 19, further comprising displaying the one or more parameters generated from the clinical context for optional editing by a user via a graphical user interface prior to the loading.

22. The analytical tool integration method of claim 18, further comprising:
generating clinical decision support for the medical patient using a guideline- or rule-based clinical decision support (CDS) system;
wherein the storing, identifying, invoking, and responding are performed responsive to a failure of the generating of clinical decision support.

23. A non-transitory storage medium storing instructions executable by an electronic data processing device to perform a method as set forth in claim 18.
